(19) United States
(12) Patent Application Publication
(10) Pub. No.: US 2005/0100381 A1
(43) Pub. Date: May 12, 2005

(54) Computer keyboard easy read system attachments

(76) Inventor: Melanie Elder, Roosevelt, NY (US)

Correspondence Address: ROGER M. RATHBUN, 13 MARGARITA COURT, HILTON HEAD ISLAND, SC, 29926, US

(21) Appl. No.: 10/704,278

(22) Filed: Nov. 7, 2003

(51) Int. Cl. B41J 5/08

(52) U.S. Cl. 400/472

(57) ABSTRACT

A system for improving the visibility and readability of keys of a computer keyboard. The system includes a plurality of attachments that have enlarged indicia as compared with the size of normal indicia of standard keyboards. The attachments are provided with an adhesive layer and are sold releasably affixed to a backing. The attachments are readily peeled off of the backing and can be adhered to the keys of the keyboard by that same layer of adhesive such that the keys have the attachments affixed thereto with larger easier to read indicia.

### BACKGROUND OF THE INVENTION

The present invention relates to computer keyboards and, more particularly, to a plurality of large type sized letter and other indicia that can be adhered to the normal keys of a keyboard to make the reading of the indicia on the keys easier.

With computers, there is, of course, a keyboard that has certain indicia permanently impressed thereon including letters, numbers and certain instructional indicia used to carry out some function of the computer. For example, there are words or shortened words or certain keys such as shift, ctrl, tab and the like.

One of the difficulties, however, in the use of the typical computer keyboard is that the indicia that is permanently impressed on the keys is relatively small, compared to the external dimensions of the key, and sometimes take up only a quarter of the upper, left hand surface area of the computer key. As such, the indicia are sometimes difficult for the person to read, particularly when fatigue sets in after a lengthy session on the computer and the user's eyes become tired or, of course, simply due to poor eyesight of the user.

Accordingly, it would be advantageous to have the indicia on the keys of a computer enlarged by some convenient means that can be retrofitted to any standard computer keyboard in order to make those keys easier to read by the user and require less eye strain in operating the computer.

### SUMMARY OF THE INVENTION

The present invention provides a means of enlarging the indicia on the keys of a standard computer keyboard in a convenient, easy and inexpensive manner by providing a plurality of attachments that can be adhered to the upper surface of those keys and which have an enlarged indicia corresponding to the indicia that is permanently impressed on the individual keys. The attachment can be a heavy paper composition to incur a low cost of production but be sufficiently durable to be lasting when used on the keyboard or a computer. Other materials such as plastic materials could also be used in accordance with the invention.

With the present invention, therefore, the attachments are designed to have indicia that corresponds to the indicia permanently on the individual keys to which the attachments are adhered so that the keyboard remains exactly the same with the exception that the attachments have that indicia enlarged with respect to the original indicia on the keys such that the attachments facilitate the readability of those keys of the keyboard.

As such, one surface of the attachment bears the corresponding indicia while the other surface is adapted to be adhered to each key of the computer keyboard by some adhering means, prefer a coating of a self-adhesive material on that surface of each attachment.

The enlarged indicia on the attachment takes up substantially the entire area of the one surface, that is, rather than taking up a low percentage of the surface, i.e. 25 percent, the enlarged indicia may, preferably, take up substantially the entire surface of the attachment so that the indicia is relatively easy to read, even after considerable eye fatigue.

In the preferred embodiment, the individual attachments are provided to a customer on a backing such that the various attachments are releasable affixed to the backing and the attachments can simply be peeled off the backing and adhered, by the user, to the keys of a computer keyboard by means of the adhesive coating on the attachments.

Other features of the present system of attachments will become apparent in light of the following detailed description of a preferred embodiment thereof and as illustrated in the accompanying drawings.

### BRIEF DESCRIPTION OF THE DRAWINGS

FIG. 1 is a view of the attachment of the present invention affixed to a backing;

FIG. 2 is an enlarged front view of one of the attachments of FIG. 1; and

FIG. 2 is a side view of one of the attachments of FIG. 1.

### DETAILED DESCRIPTION OF THE INVENTION

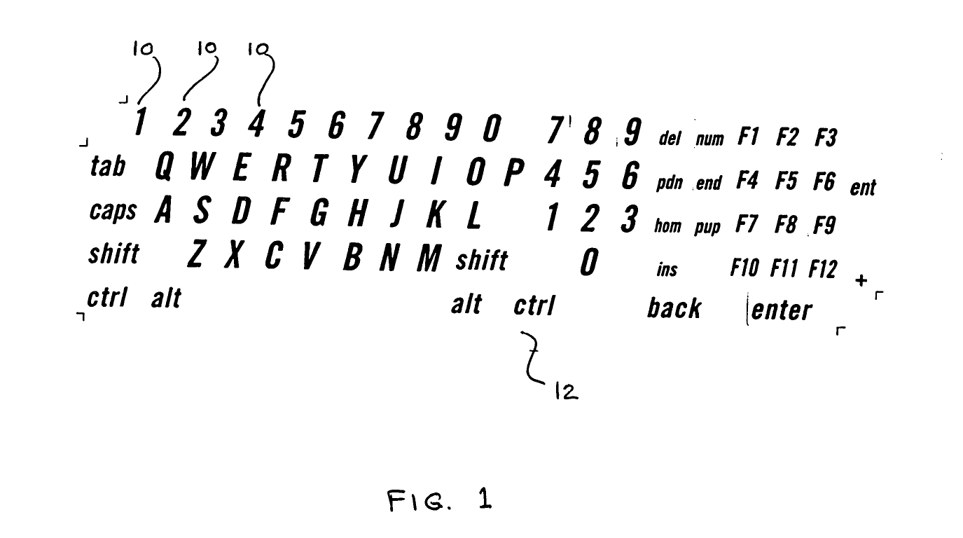

Referring now to FIG. 1, there is shown a view of the present invention and which comprises a plurality of attachments 10 that are releasable affixed to a backing 12. As can be seen, the attachments 10 are generally rectangular in shape and include certain ones having numbers, letters, words and some that are portions of words, and combination of letters and numbers, that is, the entire gamut of the standard keys found on a normal computer keyboard.

The attachments 10 are affixed to the backing by a releasable adhesive coating that is located on the surface of the attachments 10 that contact the backing 12 and thus, the releasable feature allows each attachment to be simply peeled off of the backing and the adhesive can thereafter be used to affix the attachment 10 to the keys of a computer keyboard. To make the attaching process simpler, the orientation of each of the attachments 10 is preferably located on the backing 12 in the appropriate location of the corresponding key of a standard computer keyboard.

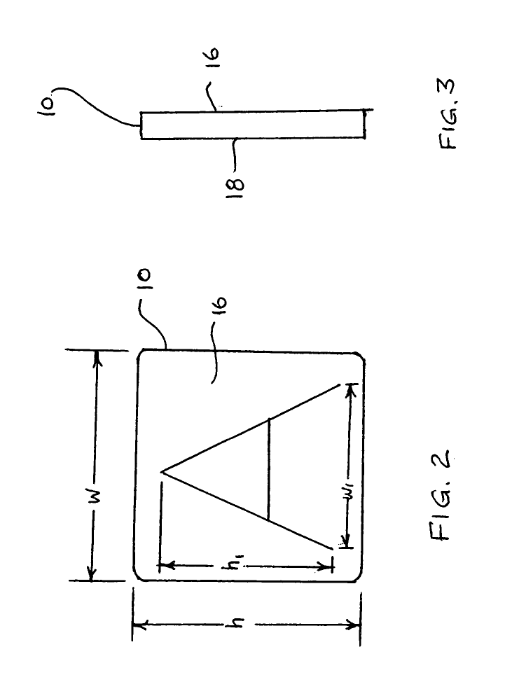

Turning now to FIG. 2, there is shown a front view of an attachment 10 illustrating the letter A as an example. The external dimensions of the attachment, that is, the width w and the height h, are sized so as to be essentially the same as the external dimensions of a key of a typical, commercial computer keyboard. According, in the preferred embodiment, the attachment 10 can be adhered to the outer face of a key of a computer keyboard and essentially cover that entire outer face and thus allow the indicia on the attachment 10 to be as large as possible in carrying out the purposes of the present invention.

As also can be seen in FIG. 2, the letter A is considerable larger that the same letter of a standard computer keyboard where a letter may take up about 25 percent of the outer surface of a standard key. With the letter A of the attachment 10, the height h₁ of the letter A and the width w₁ of the letter A is just, respectively, less than the height h and width w of the attachment 10 itself, and, typically, if the attachment height h is about 9/16^{ths} of an inch, the letter itself on the attachment 10 can have a height h₁ of about 7/16^{ths} of an inch, or about 70-80 percent of that height h of the attachment 10. The width w₁ of the letter or other indicia on the attachment 10 can also be preferable about 70-80 percent of the width w of the attachment 10.

Turning finally to FIG. 3, there is shown a side view of an attachment 10 constructed in accordance with the present invention and where the attachment has a first side 16 that has the indicia printed thereon and a second side 18 that has an adhesive coating thereon to enable the attachment 10 to be readily affixed to the key of a computer keyboard.

It will be understood that the scope of the invention is not limited to the particular embodiment disclosed herein, by way of example, but only by the scope of the appended claims.

1. A plurality of attachments adapted to be adhered to individual keys of a computer keyboard, each of the individual keys having characteristic indicia permanently fixed thereon, each of said attachments having indicia on one surface thereof individually corresponding to the permanent indicia on corresponding keys of the computer keyboard, said attachments having external dimensions conforming to the external dimensions of the individual corresponding keys, the indicia on the attachments being larger than the indicia on the corresponding keys of the computer keyboard to enable a user to better view and identify the individual keys of the computer keyboard.

2. The plurality of attachments as defined in claim 1 wherein the surface of the attachment opposite the one surface having the indicia is a surface adapted to adhere to the keys of the computer keyboard.

3. The plurality of attachments as defined in claim 1 wherein the surface of the attachment opposite the one surface having the indicia is a self-adhesive surface.

4. The plurality of attachments as defined in claim 1 wherein the indicia on the one surface includes numbers, letters and words indicative of a performance function of the computer.

5. The plurality of attachments as defined in claim 1 wherein the indicia on the one surface of the attachments are sized to be slightly less than the surface area of the one surface.

6. The plurality of attachments as defined in claim 5 wherein the height of the indicia on the attachment is about 75-80 percent of the height of the attachment.

7. The plurality of attachments as defined in claim 1 wherein the height of the letters and numbers on the one surface of the attachments have a height that is about 70-80 percent of the height dimension of the attachments.

8. The plurality of attachments as defined in claim 1 wherein the width of the letters and numbers on the one surface of the attachments have a width that is about 70-80 percent of the width dimension of the attachments.

9. A method of improving the visibility of the individual keys of a computer keyboard, said method comprising the steps of:
providing a plurality of individual attachments having external dimensions adapted to conform to the external dimensions of corresponding individual keys of the computer keyboard, the attachments each having indicia thereon,
affixing each of the individual attachments to the corresponding keys of the computer keyboard.

10. The method as defined in claim 9 wherein the step of providing a plurality of individual attachments comprises providing attachments having an adhesive surface.

11. The method as defined in claim 10 wherein the step of affixing the attachments comprises contacting the adhesive surfaces of the attachment with the individual keys of the compute keyboard.

12. The method as defined in claim 9 wherein the step of affixing each of the attachments comprises affixing each attachment having indicia of a predetermined size onto a key of the computer keyboard having the same indicia of a smaller size.

13. The method as defined in claim 12 wherein the step of affixing the attachments comprises affixing attachments having indicia having a height and width about 70-80 percent of the height and width, respectively, of the keys of the computer keyboard.

14. A system for enhancing the readability of the indicia on keys of a computer keyboard, said system comprising:
a backing,
a plurality of attachments releasably secured to said backing, said plurality of attachments adapted to be adhered to individual keys of a computer keyboard, each of said attachments having indicia on one surface thereof individually corresponding to the indicia on corresponding keys of the computer keyboard, said attachments having external dimensions conforming to the external dimensions of the keys on a computer keyboard, the indicia on the attachments being larger than the indicia on the keys of the computer keyboard to enable a user to better view and identify the individual keys of the computer keyboard.

15. The system as defined in claim 14 wherein the said plurality of attachments are releasably secured to said backing by means of a layer of adhesive on a side of said attachments.

16. The system as defined in claim 15 wherein said layer of adhesive is also used to adhere the attachments to the keys of the computer keyboard.

17. The system as defined in claim 14 wherein the attachments have a predetermined height and width to conform to the dimensions of the keys of the computer keyboard.

18. The system as defined in claim 17 wherein said indicia on the attachment is about 70-80 percent of the height of the attachments.

19. The system as defined in claim 14 wherein said attachments are oriented on said backing in generally the same locations as the corresponding keys of a computer keyboard
